(19) United States
(12) Patent Application Publication
(10) Pub. No.: US 2021/0110608 A1
(43) Pub. Date: Apr. 15, 2021

(54) VIRTUAL WINDOW SYSTEM

(71) Applicant: MSG Sports and Entertainment, LLC, New York, NY (US)

(72) Inventor: Stuart ELBY, Westport, CT (US)

(73) Assignee: MSG Sports and Entertainment, LLC, New York, NY (US)

(21) Appl. No.: 16/597,563

(22) Filed: Oct. 9, 2019

(51) Int. Cl. G06T 19/00; G06T 15/20; G06F 3/01; G02B 27/01; G06F 3/0481; G06T 19/20

(52) U.S. Cl. CPC G06T 19/006; G06T 15/20; G06F 3/011; G02B 2027/014; G06F 3/017; G06F 3/04815; G06T 19/20; G02B 27/017

(57) ABSTRACT

A virtual window system emulates a real-window when being viewed by a person. As the person moves closer toward the virtual window system, the image being displayed by the virtual window system changes to emulate the person moving closer toward the real-world window. And as the person moves away from the virtual window system, the image being displayed by the virtual window system changes to emulate the person moving away from the real-world window.

### BACKGROUND

Windows represent openings typically covered by glass in structures allowing persons to view the outdoors. Windows effectively bring the outdoors inside with the views of the natural world having a profound positive effect on health and well-being. Windows allow natural light to enter into those structures providing a more soothing atmosphere. Moreover, structures often include windows for many practical and decorative reasons. For example, structures having windows tend to be more desirable. As another example, windows provide functional art to the structures making those structures having windows appear larger from inside and adding economic value.

### BRIEF DESCRIPTION OF THE DRAWINGS

Aspects of the present disclosure are best understood from the following detailed description when read with the accompanying figures. It is noted that, in accordance with the standard practice in the industry, features are not drawn to scale. In fact, the dimensions of the features may be arbitrarily increased or reduced for clarity of discussion.

FIG. 1 illustrates a pictorial representation of an exemplary environment having an exemplary virtual window system according to an exemplary embodiment of the present disclosure;

FIG. 2 illustrates an exemplary image that can be displayed by the exemplary virtual window system according to an exemplary embodiment of the present disclosure;

FIG. 3A through FIG. 3C graphically illustrate first exemplary fields of view of the exemplary window system according to an exemplary embodiment of the present disclosure;

FIG. 4A through FIG. 4C graphically illustrate second exemplary fields of view of the exemplary window system according to an exemplary embodiment of the present disclosure;

FIG. 5A through FIG. 5D graphically illustrate exemplary adaptations of an image or series of images displayed by the exemplary window system according to an exemplary embodiment of the present disclosure;

FIG. 6A through FIG. 6C graphically illustrates a first exemplary geometric projection technique to determine a viewable image area from an image according to an exemplary embodiment of the present disclosure;

FIG. 7 graphically illustrates a second exemplary geometric projection technique to determine a viewable image area from an image according to an exemplary embodiment of the present disclosure;

FIG. 8 illustrates a cutaway block diagram of a first exemplary virtual window system according to an exemplary embodiment of the present disclosure; and

FIG. 9 illustrates a block diagram of a second exemplary virtual window system according to an exemplary embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the examples. This repetition does not in itself dictate a relationship between the embodiments and/or configurations discussed.

### OVERVIEW

A virtual window system emulates a real-window when being viewed by a person. As the person moves closer toward the virtual window system, the image being displayed by the virtual window system changes to emulate the person moving closer toward the real-world window. And as the person moves away from the virtual window system, the image being displayed by the virtual window system changes to emulate the person moving away from the real-world window.

### EXEMPLARY ENVIRONMENT

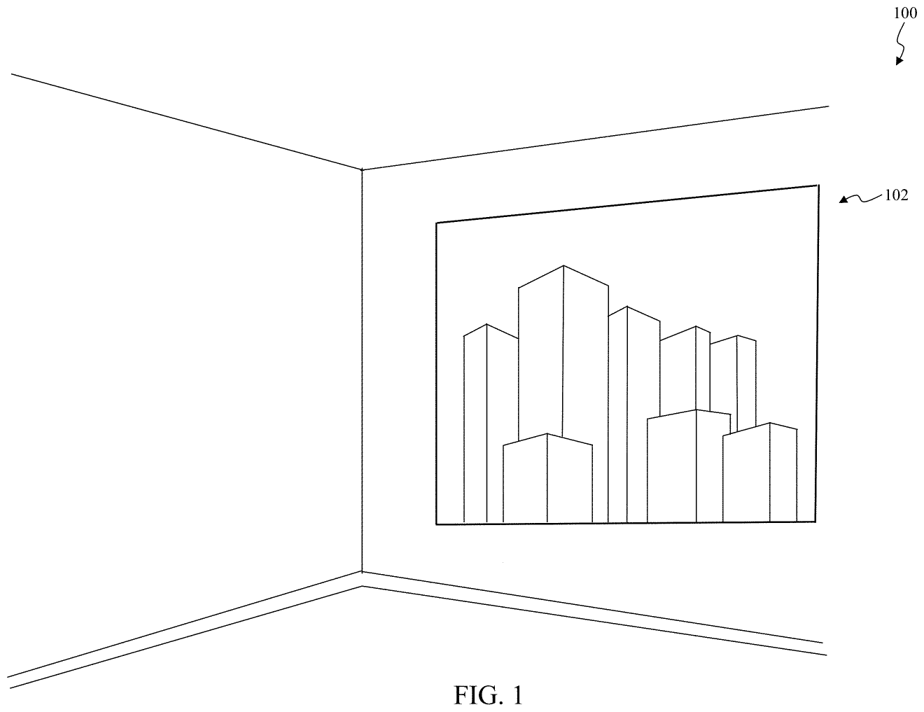

FIG. 1 illustrates a pictorial representation of an exemplary environment having an exemplary virtual window system according to an exemplary embodiment of the present disclosure. In the exemplary embodiment illustrated in FIG. 1, an environment 100 represents a location within one or more building and/or nonbuilding structures having a virtual window system 102 which displays an image or a series or images, often referred to as a video. As to be described in further detail below, the virtual window system 102 adapts the image or a series or images, often referred to as a video, to emulate a real-world window within the one or more building and/or nonbuilding structures.

Generally, the one or more building structures refer to any suitable structure or structures that are designed for human occupancy and can include one or more residential, industrial, and/or commercial building structures. The residential building structures can be characterized as being single-family detached homes or houses, single-family attached homes or houses, and/or large multi-family homes or houses. The commercial building structures can be characterized as being office building structures, non-freestanding retail building structures, also referred to as shopping malls, freestanding retail building structures, hotel building structures, and/or special purpose commercial building structures such as self-storage building structures, theme or amusement building structures, and/or theater building structures. The industrial building structures can be characterized as being manufacturing building structures, warehouse/distribution building structures, and/or flex space building structures, such as office buildings, laboratories, data centers, call centers and/or showrooms. The residential, industrial, and/or commercial building structures can further include specialty building structures, such as educational building structures, such as elementary schools, secondary schools, colleges, or universities; civic building structures, such as arenas, libraries, museums, or community halls; religious building structures, such as churches, mosques, shrines, temples, or synagogues; government building structures, such as city halls, courthouses, fire stations, police stations, or post offices; military building structures; and/or transport building structures, such as airport terminals, bus stations, or subway stations.

Generally, the one or more non-building structures refer to any suitable structure or structures that are not designed for human occupancy and can include one or more residential, industrial, and/or commercial non-building structures. The one or more residential, industrial, and/or commercial nonbuilding structures can include aqueducts, bridges and bridge-like structures, canals, communications towers, dams, monuments, roads, signage, and/or tunnels to provide some examples.

Referring back to FIG. 1, the virtual window system 102 represents an electrical, mechanical, and/or electro-mechanical mechanism for displaying the image or the series or images to one or more persons within the environment 100. As to be described in further detail below, virtual window system 102 displays the image or the series or images. The virtual window system 102 adapts the image or the series or images in relation to the one or more persons to emulate a real-world window within the environment 100. For example, as the one or more persons move toward the virtual window system 102, the virtual window system 102 adapts the image or the series or images to emulate the one or more persons moving toward to a real-world window within the environment 100. As another example, as the one or more persons move away from the virtual window system 102, the virtual window system 102 adapts the image or the series of images to emulate the one or more persons moving away from a real-world window within the environment 100. As to be described in further detail below, the virtual window system 102 monitors a relative distance between the one or more persons and the virtual window system 102. The virtual window system 102 utilizes this relative distance to adapt the image or the series or images. In an exemplary embodiment, the virtual window system 102 can scale, crop, and/or translate the image or the series or images based upon this relative distance to adapt the image or the series or images.

Exemplary Image that can be Displayed by an Exemplary Virtual Window System within the Exemplary Environment

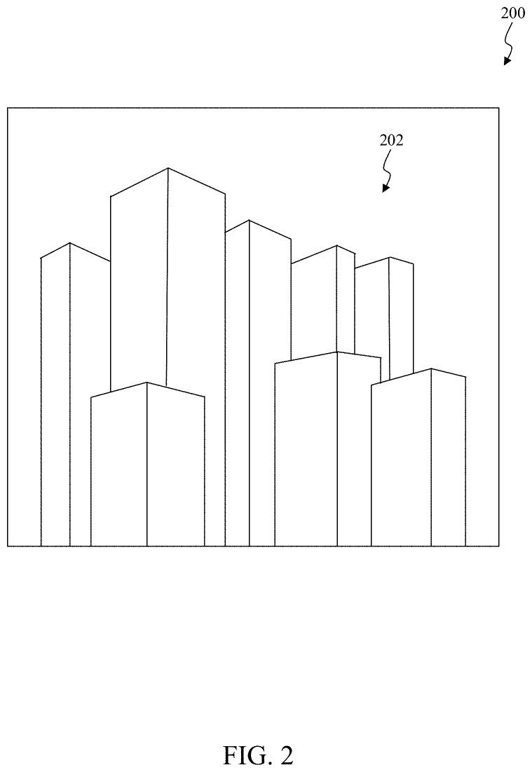

FIG. 2 illustrates an exemplary image that can be displayed by the exemplary virtual window system according to an exemplary embodiment of the present disclosure. In the exemplary embodiment illustrated in FIG. 2, a virtual window system, such as the virtual window system 102 as described above in FIG. 1, displays an exemplary image 200. The exemplary image 200 can represent the image being displayed by the virtual window system or an image from among the series or images being displayed by the virtual window system. As to be discussed in further detail below, the virtual window system adapts the exemplary image 200 to emulate a real-world window within, for example, the environment 100 as described above in FIG. 1.

In the exemplary embodiment illustrated in FIG. 2, the exemplary image 200 represents a pictorial representation of a visual scene 202. For example, the visual scene 202 can represent a visualization of urban ecosystem having one or more commercial building structures as described above in FIG. 1. In this example, the one or more commercial building structures include high-rise buildings, such as the skyscrapers illustrated in FIG. 2, to provide an example. It should be noted the visual scene 202 as illustrated in FIG. 2 is for exemplary purposes only. Those skilled in the relevant art(s) will recognize the visual scene 202 can represent pictorial representations of other ecosystems without departing from the spirit and scope of the present invention. These other ecosystems can include other urban ecosystems and/or any suitable aquatic and/or terrestrial ecosystem that will be apparent to those skilled in the relevant art(s) without departing from the spirit and scope of the present disclosure. Alternatively, or in addition to, the visual scene 202 can represent a visualization of an event. This event can represent a musical event, a theatrical event, a sporting event, a motion picture, and/or any other suitable event that will be apparent to those skilled in the relevant art(s) without departing the spirit and scope of the present disclosure. Moreover, or in further addition to, the visual scene 202 can represent an extra-terrestrial scene such as a visualization of the surface of the Moon or Mars to provide some examples. In some situations, the visual scene 202 can be created using computer-generated imagery (CGI).

In an exemplary embodiment, the exemplary image 200 is captured in real-time, or in near time, by a remote camera. The remote camera can be situated onto the exterior of one or more building and/or nonbuilding structures, as described above in FIG. 1, to capture the exemplary image 200 from the exterior of these structures. Alternatively, or in addition to, the remote camera can be situated within one or more building and/or nonbuilding structures, as described above in FIG. 1, to capture the exemplary image 200 within the interior of these structures.

Generally, the remote camera captures the exemplary image 200 at a sufficient resolution to allow the exemplary image 200 to be adapted by the virtual window system to emulate the real-world window. For example, the virtual window system scales, e.g., stretches, the exemplary image 200 in some situations as to be described in further detail below. In this example, the remote camera captures the exemplary image 200 at a sufficient resolution that allows the virtual window system to scale the exemplary image 200 without introducing pixilation into the exemplary image 200 as it is being displayed by the virtual window system. In an exemplary embodiment, this sufficient resolution can include a resolution of at least: 1280×720 pixels, 1440×1080 pixels, 1920×1080 pixels, 1998×1080 pixels, 2048×1080 pixels, 3840×2160 pixels, 4096×2160 pixels, 7680×4320 pixels, 15360×8640 pixels, or 61440×34560 pixels to provide some examples.

Additionally, the remote camera captures the exemplary image 200 at a sufficient field of view, for example, an approximate 180-degree field of view, to allow the exemplary image 200 to be adapted by the virtual window system. For example, the virtual window system selects a viewable image area from the exemplary image 200 based upon distances between one or more persons and the virtual window system 102 as to described in further detail below. In this example, the remote camera captures the exemplary image 200 at a sufficient field of view that allows the virtual window system to select different viewable image areas for a wide range of distances between the one or more persons and the virtual window system 102.

Exemplary Fields of View that can be Visualized by One or More Persons Viewing the Exemplary Virtual Window System

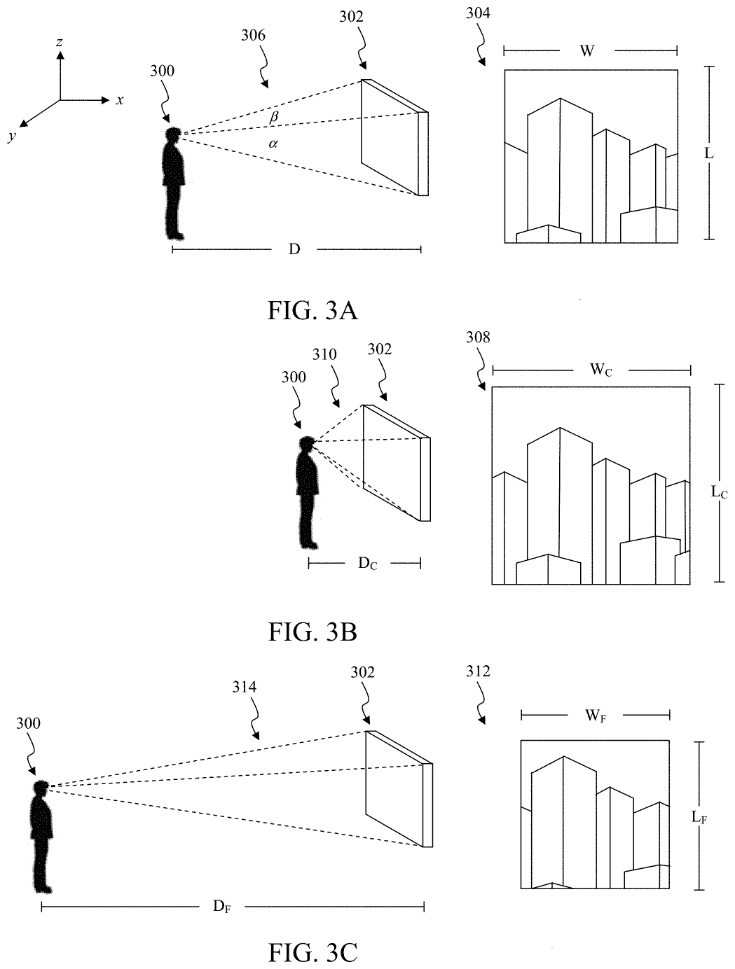

FIG. 3A through FIG. 3C graphically illustrate first exemplary fields of view of the exemplary window system according to an exemplary embodiment of the present disclosure. A person 300 viewing a virtual window system 302 observes an image, such as the exemplary image 200 as described above in FIG. 2, being displayed the virtual window system 302. In the exemplary embodiments illustrated in FIG. 3A through FIG. 3C, the virtual window system 302 selects a viewable image area from the image corresponding to a field of view of the scene of the person 300 to adapt the image to the field of view of the scene. The field of view of the scene is relative to a distance between the person 300 and the virtual window system 302 and can vary for different distances between the person 300 and the virtual window system 302. As to be described in further detail below, the virtual window system 302 increases the viewable image area, and thus the field of view of the scene, as the person 300 moves closer to the virtual window system 302. In this situation, the virtual window system 302 selects more of the image causing the person 300 to view a wider field of view of the scene to emulate the person 300 moving closer to the real-world window. As to be described in further detail below, the virtual window system 302 decreases the viewable image area, and thus the field of view of the scene, as the person 300 moves away from the virtual window system 302. In this situation, the virtual window system 302 selects less of the image causing the person 300 to view a narrower field of view of the scene to emulate the person 300 moving away from to the real-world window.

Moreover, in the exemplary embodiments illustrated in FIG. 3A through FIG. 3C, the virtual window system 302 scales, e.g., stretches, the viewable image area to occupy a display area of the virtual window system 302 to adapt the viewable image area to the field of view of the window. The field of view of the window, like the field of view of the scene, is relative to the distance between the person 300 and the virtual window system 302 and can vary for different distances between the person 300 and the virtual window system 302. As to be described in further detail below, the virtual window system 302 appears to be larger as the person 300 moves closer to the virtual window system 302 and the virtual window system 302 appears to be smaller as the person 300 moves away from the virtual window system 302. The scaling of the viewable image area similarly causes the viewable image area being displayed by the virtual window system 302 to appear to be larger as the person 300 moves closer to the virtual window system 302 and to appear smaller as the person 300 moves away from to the virtual window system 302.

As illustrated in FIG. 3A, the virtual window system 302 determines a distance D between the person 300 and the virtual window system 302. The virtual window system 302 selects a viewable image area from the image corresponding to the distance D to adapt the image to a field of view of the scene 304. Thereafter, the virtual window system 302 scales the viewable image area to occupy a display area of the virtual window system 302 to adapt the viewable image area to a field of view of the window 306 to emulate the person 300 viewing a real-world window. In an exemplary embodiment, the fields of view of the window used herein can be calculated approximately as:

$$\begin{matrix}α = 2 \times {tan}^{- 1} \frac{L}{2 D} , and & ( 1 ) \\ β = 2 \times {tan}^{- 1} \frac{W}{2 D} , & ( 2 )\end{matrix}$$

where α represents a vertical angle about a x-z plane of a three-dimensional Cartesian coordinate system between the person and the virtual window system, β represents a horizontal angle about a x-y plane of the three-dimensional Cartesian coordinate system between the person and the virtual window system, L represents a vertical length of the virtual window system about the z-axis of the three-dimensional Cartesian coordinate system, W represents a horizontal width of the virtual window system about a y-axis of a three-dimensional Cartesian coordinate system, and D represents the distance between the person and the virtual window system along the x-axis of the three-dimensional Cartesian coordinate system.

In the exemplary embodiment illustrated in FIG. 3B, the person 300 has moved closer to the virtual window system 302. The virtual window system 302 determines a distance D_{C}, less than the distance D, between the person 300 and the virtual window system 302. The virtual window system 302 selects a viewable image area from the image corresponding to the distance D_{C} to adapt the image to a field of view of the scene 308. The viewable image area selected at the distance D_{C} is larger than the viewable image area selected at the distance D to emulate the person 300 being closer to the virtual window system 302. The virtual window system 302 scales the viewable image area to occupy a display area of the virtual window system 302 to adapt the viewable image area to a field of view of the window 310 to emulate the person 300 being closer to the real-world window. This scaling of the viewable image area causes the virtual window system 302 to appear larger, namely, from a relative area having a Length L and a Width W to a relative area having a Length L_{C} greater than the Length L and a Width W_{C} greater than the Width W, closer to the virtual window system 302.

In the exemplary embodiment illustrated in FIG. 3C, the person 300 has moved away from the virtual window system 302. The virtual window system 302 determines a distance D_{F}, greater than the distance D, between the person 300 and the virtual window system 302. The virtual window system 302 selects a viewable image area from the image corresponding to the distance D_{C} to adapt the image to a field of view of the scene 312. The viewable image area selected at the distance D_{C} is smaller than the viewable image area selected at the distance D to emulate the person 300 being away from the virtual window system 302. The virtual window system 302 scales the viewable image area to occupy a display area of the virtual window system 302 to adapt the viewable image area to a field of view of the window 314 to emulate the person 300 being away from the real-world window. This scaling of the viewable image area causes the virtual window system 302 to appear smaller, namely, from a relative area having a Length L and a Width W to a relative area having a Length L_{F} less than the Length L and a Width W_{F} less than the Width W, away from the virtual window system 302.

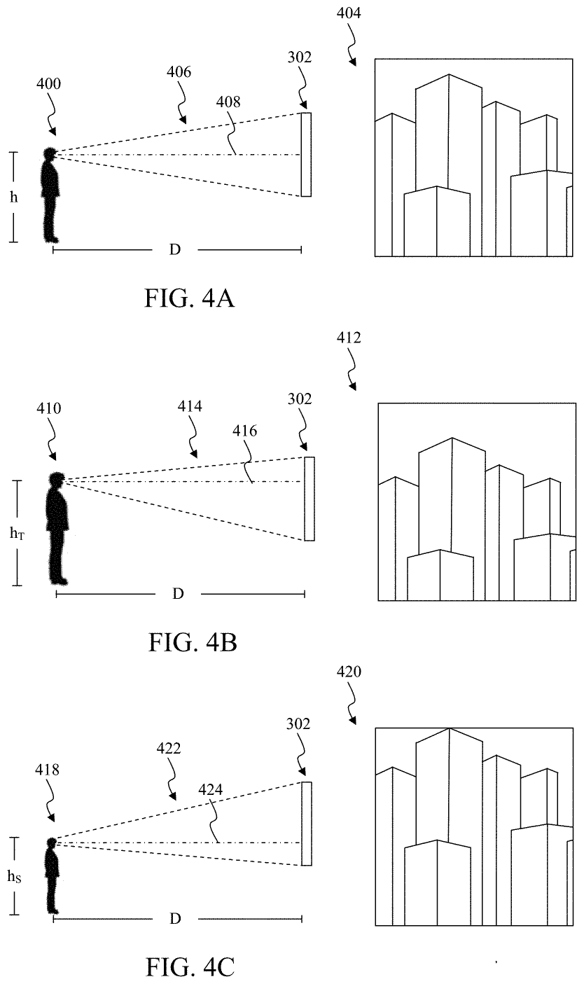

FIG. 4A through FIG. 4C graphically illustrate second exemplary fields of view of the exemplary window system according to an exemplary embodiment of the present disclosure. As to be described in further detail below, the virtual window system 302 can further consider one or more physical attributes of a person, such as line of sight to provide an example, in addition to the distance between the person and the virtual window system 302 as described above in FIG. 3A through FIG. 3C, when emulating the real-world window. The one or more physical attributes of different persons can cause different persons to have different lines of sight. For example, a taller person can have a higher line of sight when viewing the virtual window system 302 compared to a shorter person having a lower line of sight. As to be described in further detail below, the virtual window system 302 can further adapt the viewable image area according to the one or more physical attributes to better emulate the real-world window.

As illustrated in FIG. 4A, the virtual window system 302 determines the distance D between a person 300, having a height h, and the virtual window system 302 and a line of a line of sight 408 of the person 400. The virtual window system 302 selects a viewable image area from the image corresponding to the distance D and to the line of sight 408 of the person 400 to adapt the image to a field of view of the scene 404. Thereafter, the virtual window system 302 scales the viewable image area to occupy a display area of the virtual window system 302 to adapt the viewable image area to a field of view of the window 406 to emulate the person 400 viewing a real-world window.

In the exemplary embodiment illustrated in FIG. 4B, a person 410 having a height h_{T} greater than the height h, is viewing the virtual window system 302 at the distance D from a line of sight 416. The virtual window system 302 selects a viewable image area from the image corresponding to the distance D and to the line of sight 416 of the person 410 to adapt the image to a field of view of the scene 412. In the exemplary embodiment illustrated in FIG. 4B, the viewable image area can be characterized as being translated in a vertical downward direction when compared to the viewable image area as described above in FIG. 4A to correspond to the line of sight 416 of the person 410 which is above the line of sight 408 of the person 400. Thereafter, the virtual window system 302 scales the viewable image area to occupy a display area of the virtual window system 302 to adapt the viewable image area to a field of view of the window 414 to emulate the person 400 viewing a real-world window.

In the exemplary embodiment illustrated in FIG. 4C, a person 418 having a height h_{C} less than the height h, is viewing the virtual window system 302 at the distance D from a line of sight 424. The virtual window system 302 selects a viewable image area from the image corresponding to the distance D and to the line of sight 424 of the person 418 to adapt the image to a field of view of the scene 420. In the exemplary embodiment illustrated in FIG. 4C, the viewable image area can be characterized as being translated in a vertical upward direction when compared to the viewable image area as described above in FIG. 4A to correspond to the line of sight 424 of the person 418 which is below the line of sight 408 of the person 400. Thereafter, the virtual window system 302 scales the viewable image area to occupy a display area of the virtual window system 302 to adapt the viewable image area to a field of view of the window 422 to emulate the person 418 viewing a real-world window.

Although the discussion of FIG. 4A through FIG. 4C above illustrate different lines of sight along the z-axis of the three-dimensional Cartesian coordinate system as illustrated in FIG. 3A, those skilled in the relevant art(s) will recognize that the teachings herein are applicable to other lines of sight within the y-z plane of the three-dimensional Cartesian coordinate system as illustrated in FIG. 3A without departing from the spirit and scope of the present disclosure. These other lines of sight within the y-z plane can be, for example, attributed to the virtual window system 302 being viewed to the right, to the left, above, or below an approximate center of the virtual window system 302. In these situations, the line of sight can be characterized as being is offset from the approximate center of the virtual window system 302. The virtual window system 302 selects a viewable image area from the image corresponding to the distance D and to the line of sight, which is offset from the approximate center of the virtual window system 302, to adapt the image to a field of view of the scene. Thereafter, the virtual window system 302 scales the viewable image area to occupy a display area of the virtual window system 302 to adapt the viewable image area to a field of view of the window to emulate the real-world window.

Exemplary Adaptions to Emulate the Real-World Window

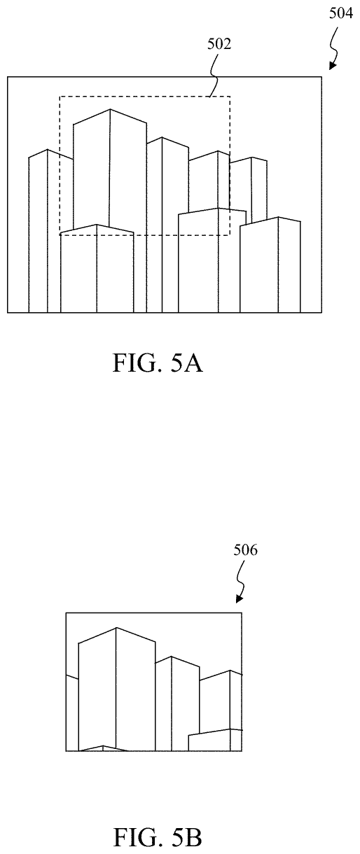

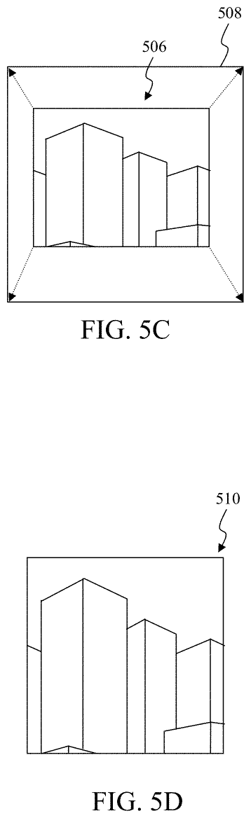

FIG. 5A through FIG. 5D graphically illustrate exemplary adaptations of an image or series of images displayed by the exemplary window system according to an exemplary embodiment of the present disclosure. A virtual window system, such as the virtual window system 102 as described above in FIG. 1 or the virtual window system 302 as described above in FIG. 3A through FIG. 3C and FIG. 4A through 4C, determines a relative distance between a person viewing the virtual window system and the virtual window system and a line of sight of the person viewing the virtual window system. The virtual window system selects a viewable image area from the image corresponding to the relative distance and the line of sight of the person to adapt the image to a field of view of the scene. Thereafter, the virtual window system scales the viewable image area to occupy a display area of the virtual window system to adapt the viewable image area to a field of view of the window to emulate the person viewing a real-world window.

In an exemplary embodiment illustrated in FIG. 5A, the virtual window system determines a relative distance between a person and the virtual window system as described above in FIG. 3A through FIG. 3C and/or a height of the person viewing the virtual window system. As illustrated in FIG. 5A, the virtual window system selects a viewable image area 502 from an image 504 that corresponds to the distance D and the line of sight of the person to adapt the image 504 to a field of view of the scene 506 as illustrated in FIG. 5B. As discussed above, the viewable image area 502 can be different sizes depending upon the relative distance between the person and the virtual window system and a height of the person viewing the virtual window system. For example, the viewable image area 502 can characterized as being larger for closer relative distances indicating the person is closer to the virtual window system and can be smaller for farther relative distances indicating the person is away from the virtual window system. As another example, the viewable image area 502 can characterized as being translated in a vertical downward direction for taller persons and as being translated in a vertical upward direction for taller shorter. As to be described in further detail below, the virtual window system can utilize geometric projection techniques to select the viewable image area 502 from the image 504.

Thereafter, the virtual window system scales the viewable image area 502 adapted to the field of view of the scene 506 to occupy a display area 508 of the virtual window system as illustrated in FIG. 5C to further adapt the viewable image area 502 to a field of view of the window 510 to as illustrated in FIG. 5D to emulate the person viewing a real-world window. The virtual window system can stretch the viewable image area 502 adapted to the field of view of the scene 506 outward to occupy the display area 508 as illustrated in FIG. 5C or can inward to occupy the display area 508 as illustrated in FIG. 5C which is not illustrated.

Exemplary Selection of the Viewable Window

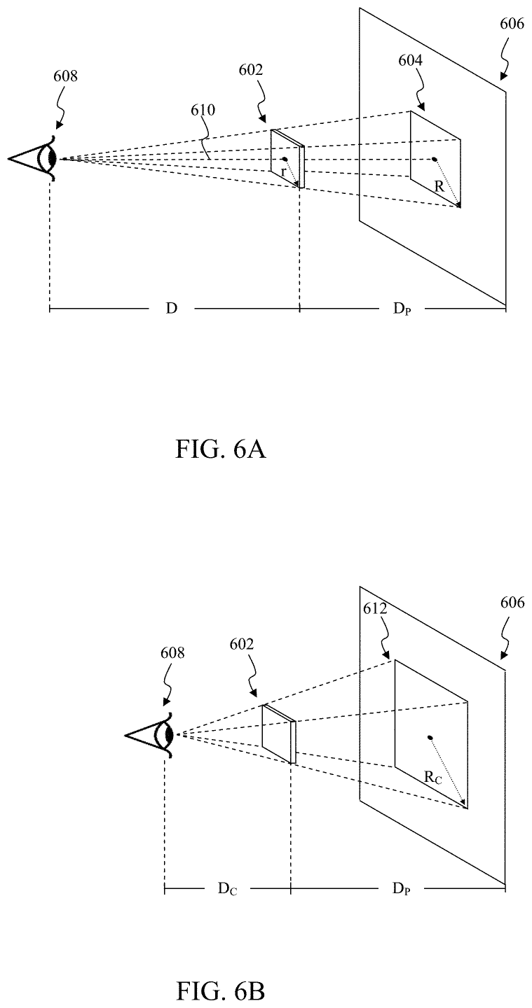

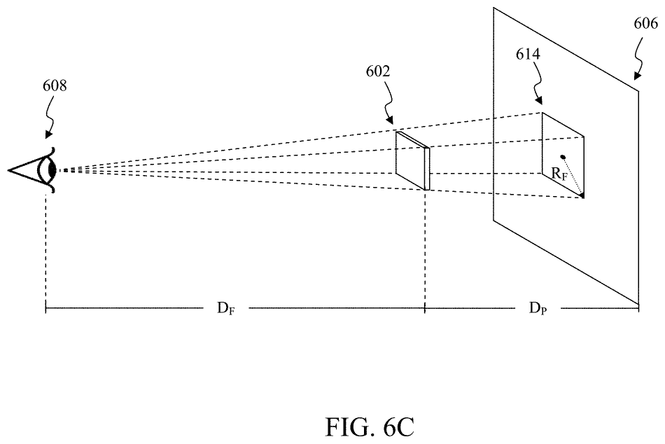

FIG. 6A through FIG. 6C graphically illustrates a first exemplary geometric projection technique to determine a viewable image area from an image according to an exemplary embodiment of the present disclosure. As described above, a virtual window system, such as the virtual window system 102 as described above in FIG. 1 or the virtual window system 302 as described above in FIG. 3A through FIG. 3C and FIG. 4A through 4C, determines a relative distance between a person and the virtual window system as described above. As to be described in further detail below, the virtual window system utilizes geometric projection techniques, for example, the geometric law of similar triangles, to select a viewable image area from an image that corresponds to the relative distance between a person and the virtual window system. These geometric projection techniques represent a transformation between the virtual window system and the image by connecting corresponding points between the virtual window system and the image with parallel lines as to be described in detail below.

In the exemplary embodiment illustrated in FIG. 6A, a virtual window system 602 selects a viewable image area 604 from an image 606, such as the exemplary image 200 as describe above inn FIG. 2, that corresponds to a distance D between the virtual window system 602 and a person 608. As illustrated in FIG. 6A, the person 608 viewing a center of a virtual window system 602 at a distance D can be assume to have a line of sight 610 that extends through an approximate center of the virtual window system 602. The line of sight 610 extends through the approximate center of the virtual window system 602 onto a plane corresponding to the image 606. As illustrated in FIG. 6A, a radial distance between the approximate center of the virtual window system 602 and a vertex of the virtual window system 602 can be denoted as a radius r. As also illustrated in FIG. 6A, a radius R projected onto the image 606 between an approximate center of the viewable image area 604 and a vertex of the viewable image area 604 can be denoted as a radius R. Through the geometric law of similar triangles, the radius R, can be denoted as:

$$R = \frac{r \times ( D + {D}_{P} )}{D} , \qquad ( 3 )$$

where D_{P} represents a hypothetical distance D between the virtual window system 602 and the image 606 which is fixed. As illustrated in FIG. 6B and FIG. 6C, a radius R_{C} and a radius R_{D} can be similarly determined for a distance D_{C} between the person 608 and the virtual window system 602 which is less than the distance D and a distance D_{F} between the person 608 and the virtual window system 602 which is greater than the distance D, respectively.

Generally, the distance D_{P} as illustrated in FIG. 6A through FIG. 6C is artistically chosen such that the viewable image area 604 provides the person 608 with a sense of realism when viewing the viewable image area 604 at the distance D. The distance D_{P} can be considered a magnification index for the image 606. In the exemplary embodiments illustrated in FIG. 6A through FIG. 6C, smaller distances for the distance D_{P} means that the viewable image area 604 is being viewed closer as compared to larger distances for the distance D_{P} which means that the viewable image area 604 is being viewed farther away. As an example, for the distance D as illustrated in FIG. 5A, the viewable image area 604 can be configured to capture more of the image 606 by decreasing the distance D_{P} thus causing the objects within the viewable image area 604 to appear to be smaller in size and opposed to appearing larger in size which can be accomplished by increasing the distance D. In some situations, the distance D_{P} can be dynamically determined within the environment 100. For example, the person 608 may adjust the distance D_{P} until one or more features within the viewable image area 604, such as one of the skyscrapers as illustrated in FIG. 2, appear to be proportional to the view of these one or more features from the environment 100.

As to be described in further detail below, the virtual window system 602 calculates various viewable image areas, such as the viewable image area 604, the viewable image area 612, and the viewable image area, for a wide variety of distances, for example, the distance D, the distance D_{C}, and the distance D. In an exemplary embodiment, the virtual window system 602 calculates viewable image areas in distance increments of one inch increments, one foot increments, or any other suitable increments for the environment 100 that will be apparent to those skilled in the relevant art(s) without departing from the spirit and scope of the present disclosure. This allows the virtual window system 602 to access these calculated viewable image areas without having to continually perform these geometric projection techniques as described above.

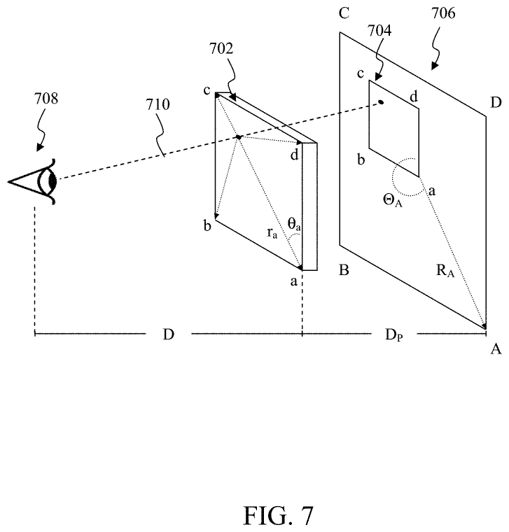

FIG. 7 graphically illustrates a second exemplary geometric projection technique to determine a viewable image area from an image according to an exemplary embodiment of the present disclosure. As described above, a virtual window system, such as the virtual window system 102 as described above in FIG. 1 or the virtual window system 302 as described above in FIG. 3A through FIG. 3C and FIG. 4A through 4C, determines a relative distance between a person and the virtual window system and a line of sight of the person as described above. As to be described in further detail below, the virtual window system utilizes geometric projection techniques, for example, the geometric law of similar triangles, to select a viewable image area from an image that corresponds to the relative distance between a person and the virtual window system and the line of sight of the person.

In the exemplary embodiment illustrated in FIG. 7, a virtual window system 702, having vertices a, b, c, and, d, selects a viewable image area 704 from an image 706, such as the exemplary image 200 as describe above in FIG. 2, having vertices A, B, C, and D. The virtual window system 702 selects the viewable image area 704 having similar vertices a, b, c, and, d, that corresponds to a distance D between the virtual window system 702 and a person 708 and a line of sight 710 of the person 708. As illustrated in FIG. 7, the line of sight 710 extends through the virtual window system 702 onto a plane corresponding to the image 706. As illustrated in FIG. 7, a radial distance between the line of sight 710 and the vertex a of the virtual window system 702 can be denoted as a radius rₐ and an angular distance between the radius rₐ and the virtual window system 702 can be denoted as θₐ. Similarly, a radial distance between the vertex a of the viewable image area 704 and the vertex A of the image 706 can be denoted as a radius R_{A} and an angular distance from the vertex a of the virtual window system 702 projected onto a plane of the image 706 can be denoted as Θ_{A}. Through the geometric law of similar triangles, the radius R_{A} and the angle Θ_{A} can be denoted as:

$$\begin{matrix}{R}_{A} = \frac{( {r}_{a} * D )}{{D}_{P}} , & ( 4 ) \\ {Θ}_{A} = {θ}_{a} + π , & ( 5 )\end{matrix}$$

where D_{P} represents the distance D_{P} as described above in FIG. 6A through 6C. The virtual window system 702 can similarly determine other radii R_{B}, R_{C}, and R_{D} and other angular distances Θ_{B}, Θ_{C}, and Θ_{D} to through similar application of the geometric law of similar triangles determine the viewable image area 704 that corresponds to the distance D and the line of sight 710 of the person 708.

Although the viewable image area 604, the viewable image area 612, the viewable image area 614, and the viewable image area 704 are illustrated as being rectangles above, this is for exemplary purposes only. Those skilled in the relevant art(s) will recognize these viewable image areas, as well as other viewable image areas discussed herein, can be any suitable geometric shape without departing from the spirit and scope of the present disclosure. These other suitable geometric shapes can include regular geometric structures, such as circles, ellipses, and/or polygons to provide some examples, and/or irregular geometric structures, such as irregular polygons to provide an example, without departing from the spirit and scope of the present disclosure. In some situations, these viewable image areas can include exclusion areas having these geometric shapes whereby the image is not displayed within these exclusion areas to allow the virtual window systems described herein to insert other images and/or other series of images into these exclusion areas, for example, computer generated text and/or graphics, such as logos and/or advertisements to provide some examples.

Preferably, shapes of the viewable image area described herein match, or at least closely approximate, a display area of the virtual window system. For example, the viewable image areas described above in FIG. 6A through FIG. 6C and FIG. 7 match the rectangular display areas of the virtual window systems described above in FIG. 6A through FIG. 6C and FIG. 7. However, although not illustrated, the shapes of the viewable image areas described herein need not match the display area of the virtual window system. For example, the viewable image area can be a circle and display area of the virtual window system can be a rectangle. In these situations, the virtual window systems described herein can overlay a difference between the shapes of the viewable image areas and the display area of the virtual window system with black space or white space to provide some examples. Alternatively, or in addition to, the difference can be overlaid with computer generated text and/or graphics, such as logos and/or advertisements to provide some examples.

Exemplary Virtual Window Systems

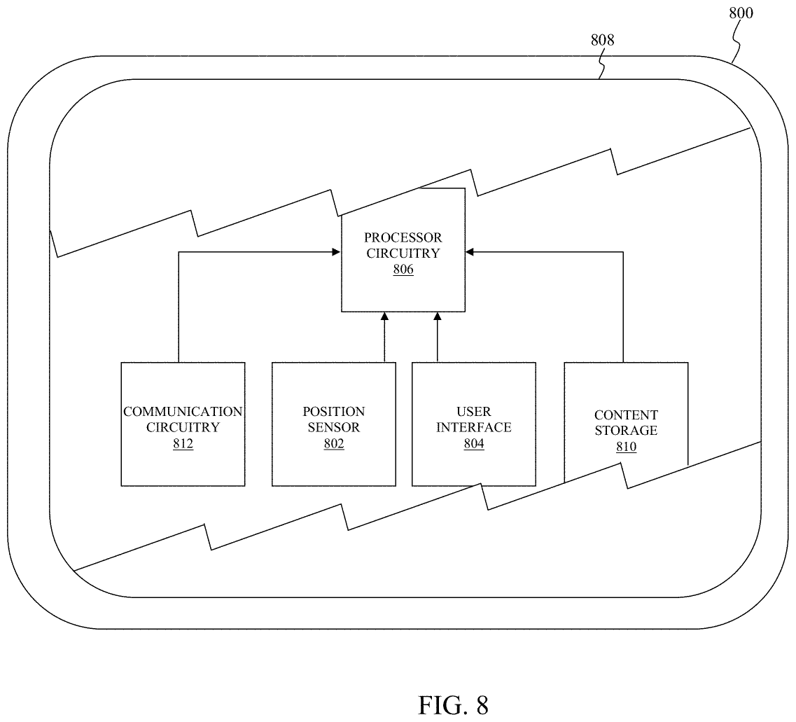

FIG. 8 illustrates a cutaway block diagram of a first exemplary virtual window system according to an exemplary embodiment of the present disclosure. A virtual window system 800 determines a distance between a person and the virtual window system 800. The virtual window system 800 selects a viewable image area from the image corresponding to the distance to adapt the image to a field of view of the scene as described above. Thereafter, the virtual window system 800 scales the viewable image area to occupy a display area of the virtual window system 800 to adapt the viewable image area to a field of view of the window to emulate the person viewing a real-world window as described above. In the exemplary embodiment illustrated in FIG. 8, the virtual window system 800 operates as stand-alone unit and can include a position sensor 802, a user interface 804, a processor circuitry 806, a display device 808, a content storage 810, and communication circuitry 812. The virtual window system 800 can represent an exemplary embodiment of the virtual window system 102 as described above in FIG. 1, the virtual window system 302 as described above in FIG. 3A through FIG. 3C and FIG. 4A through FIG. 4B, the virtual window system 602 as described above in FIG. 6A through FIG. 6C, and/or the virtual window system 702 as described above in FIG. 7.

The position sensor 802 detects for the presence of one or more persons within an environment, such as the environment 100 to provide an example. Thereafter, the position sensor 802 determines a relative distance between a person viewing the virtual window system 800 and the virtual window system 800 and a line of sight of the person viewing the virtual window system 800. The position sensor 802 can be implemented using simple position measurement electrical, electro-acoustic and/or electro-optical sensors, such as ultrasonic sensors, inductive position sensors, photodiodes or photodiodes arrays, and/or proximity sensors to provide some examples, to determine the relative distance between a person viewing the virtual window system 800 and the virtual window system 800. Alternatively, or in addition to, more complex position measurement electrical, electro-acoustic and/or electro-optical sensors having facial feature and/or recognition capabilities, such as three-dimensional cameras, three-dimensional laser scanners, three-dimensional infra-red (IR) scanners, or eye tracking sensors to provide some examples, can be used to determine the relative distance between the person viewing the virtual window system 800 and/or the virtual window system 800 and the line of sight of the person viewing the virtual window system 800. In some situations, the position sensor 802 can detect multiple persons in an environment, such as the environment 100 as described above in FIG. 1. In these situations, the position sensor 802 utilizes a rules engine to determine which person in the environment is to be used. For example, this rules engine could be set to use the first person detected by the position sensor 802 that enters its viewing range and ignore all other persons in the environment.

The user interface 804 allows one or more persons to interact with the virtual window system 800. Generally, the user interface 804 represents various electrical, mechanical, and/or electro-mechanical devices that allow a person user to interact with the virtual window system 800. These devices may be physically integrated within the virtual window system 800, such as an alphanumeric keyboard, a keypad, pointing devices such as a mouse, a trackball, a touchpad, a stylus, or a graphics tablet, a scanner, a touchscreen incorporated into the display device 808, and/or audio input devices such as voice recognition systems or microphones to provide some examples, as illustrated in FIG. 8 and/or may be remote from the virtual window system 800, such as a personal computer (PC), a tablet PC, a set-top box (STB), a personal digital assistant (PDA), a cellular telephone, a smartphone, a web appliance, a game station, a remote control to provide some examples, which is not illustrated in FIG. 8. In the exemplary embodiment illustrated in FIG. 8, the user interface 804 allows the one or more persons to select an image or a series of images, often referred to as a video, from a library of images or videos to be displayed by the virtual window system 800. As to be described in detail below, the library of images or videos can be stored locally in the content storage 810 and/or can be accessed remotely by the communication circuitry 812.

The processor circuitry 806 controls the overall configuration and/or operation of the virtual window system 800. Generally, the processor circuitry 806 has image processing capabilities to select a viewable image area from the image corresponding to the relative distance and/or the line of sight of the person provided by the position sensor 802 to adapt the image and to scale the viewable image area to occupy a display area of the display device 806 as described above. For example, the processor circuitry 806 can perform the necessary calculations, for example, the geometric law of similar triangles as described above in FIG. 6A through 6C and FIG. 7, to calculate a position of the viewable image area within the image that corresponds to the relative distance between a person and the virtual window system and/or the line of sight of the person. Alternatively, or in addition to, the processor circuitry 806 can query the content storage 810 for the position of the viewable image area within the image. Next, the processor circuitry 806 extracts the viewable image area from the image and thereafter transcodes, for example, resizes, the viewable image to scale the viewable image area to occupy a display area of the display device 806. Finally, the processor circuitry 806 provides the transcoded image to the display device 808 for display. In some situations, the processor circuitry 806 can include a dedicated graphics processing unit (GPU) to manipulate the image as described above and a central processing unit (CPU) to control aspects of the virtual window system 800.

The display device 808, which has been cutaway in FIG. 8, displays the image provided by the processor circuitry 806. The display device 808 can include a cathode ray tube (CRT), a flat-panel device such as a liquid crystal display (LCD), a projection device, or some other device for creating a visible image such as a virtual reality system that will be apparent to those skilled in the relevant(s) without departing from the spirit and scope of the present disclosure.

The content storage 810 stores the library of images or videos from which the person selects the image or the series of images, often referred to as a video. The content storage 810 can include non-transitory machine-readable mediums such as read only memory (ROM), random access memory (RAM), magnetic disk storage media, optical storage media, and/or flash memory devices to provide some examples. In the exemplary embodiment, the content storage 810 stores the library of images or videos that is remotely received by the communication circuitry 812 from a content provider, such as a cable television service provider or other media service provider to provide some examples. In another exemplary embodiment, the processor circuitry 806 can execute a calibration routine that determines various viewable image areas for a wide variety of distances, for example, in distance increments of one inch increments, one foot increments, or any other suitable increments for the environment that will be apparent to those skilled in the relevant art(s) without departing from the spirit and scope of the present disclosure. In this other exemplary embodiment, these viewable image areas are stored in the content storage 810 which are accessible by the processor circuitry 806. For example, the viewable image areas can be stored as a table within the content storage 810 which is indexed by various distances.

The communication circuitry 812 can provide remote communication capabilities to the virtual window system 800 allow the virtual window system 800 to communicate with other electrical, mechanical, and/or electro-mechanical devices. The communication circuitry 812 can communicate wirelessly in accordance with, for example, a generation of cellular network technology, such as 3G, 4G, 4G long term evolution (LTE), and/or 5G to provide some examples, a version of an Institute of Electrical and Electronics Engineers (I.E.E.E.) 802.11 communication standard, for example, 802.11a, 802.11b/g/n, 802.11h, and/or 802.11ac which are collectively referred to as Wi-Fi, an I.E.E.E. 802.16 communication standard, also referred to as WiMax, a version of a Bluetooth communication standard, a version of a ZigBee communication standard, a version of a Z-Wave communication standard, a version of a IPv6 over Low power Wireless Personal Area Networks (6LoWPAN) communication standard, a version of Insteon, an ISO/IEC 14543-3-10 communication standard, also referred to as EnOcean, and/or or any other wireless communication standard or protocol that will be apparent to those skilled in the relevant art(s) without departing from the spirit and scope of the present disclosure. Alternatively, or in addition to, communication circuitry 812 can communicate wired in accordance with a version of the Institute of Electrical and Electronics Engineers (IEEE) 802.1 communication standard and/or protocol, a version of the IEEE 802.3 communication standard and/or protocol, a version of the IEEE 1394 communication standard and/or protocol, a version of a Recommended Standard communication standard and/or protocol, such as RS-232, RS-422, or RS-485 to provide some examples, a version of a Universal Serial Bus (USB) communication standard and/or protocol, a version of a Transmission Control Protocol and the Internet Protocol (TCP/IP), and/or any other well-known suitable wired communication standard and/or protocol that will be apparent to those skilled in the relevant art(s) without departing from the spirit and scope of the present disclosure. In an exemplary embodiment, the processor circuitry 806 and the communication circuitry 812 can functionally cooperate in a similar manner as a set-top box (STB) to receive media, such as television programs and/or movies as an example, from a cable television service provider or other media service provider.

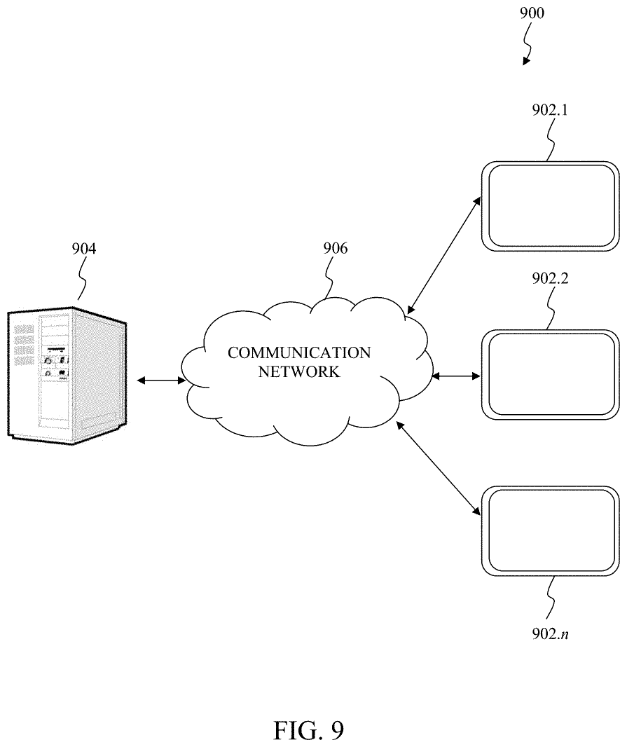

FIG. 9 illustrates a block diagram of a second exemplary virtual window system according to an exemplary embodiment of the present disclosure. A virtual window system 900 determines a distance between a person and the virtual window system 900. The virtual window system 900 selects a viewable image area from the image corresponding to the distance to adapt the image to a field of view of the scene as described above. Thereafter, the virtual window system 900 scales the viewable image area to occupy a display area of the virtual window system 900 to adapt the viewable image area to a field of view of the window to emulate the person viewing a real-world window as described above. In the exemplary embodiment illustrated in FIG. 9, the virtual window system 900 operates as distributed unit and can include virtual window devices 902.1 through 902.n and a virtual window server 904 communicatively coupled to each other via a communication network 906.

Each of the virtual window devices 902.1 through 902.n are configured and arranged in a substantially similar manner as the virtual window system 800 as described above in FIG. 8 with the exception that the image processing capabilities which are described as being within the processor circuitry 906 as described above in FIG. 8 are offloaded to the virtual window server 904. This allows the virtual window devices 902.1 through 902.n to independently operate under the management of the virtual window server 904. In some situations, the image processing capabilities as described above need to be performed using a dedicated high-performance graphics processor. Instead of including the high-performance graphics processor into each of the virtual window devices 902.1 through 902.n, this high-performance graphics processor can be included within the virtual window server 904. This reduces overall cost of the virtual window system 900. The exemplary embodiment illustrated in FIG. 9 allows the virtual window devices 902.1 through 902.n to be included in different areas of the environment, for example, different rooms of a hotel building structure, in a cost efficient manner.

The communication network 906 communicatively couples the virtual window devices 902.1 through 902.n and the virtual window server 904. For example, the virtual window devices 902.1 through 902.n can receive the processed images from the virtual window server 904 over the communication network 906 using, for example, the communication circuitry 812 as described above in FIG. 8. The communication network 906 can service represent relatively small areas, such as within a person's reach, to form a one or more wireless personal area networks (WPANs), short distances within structures, such as homes, schools, computer laboratory, or office buildings, to form one or more wireless local area networks (WLANs), one or more large areas, such as between neighboring towns and cities or a city and suburb, to form one or more wireless wide area network (WWANs), and/or any combination of WPANs, WLANs, and/or WWANs that will be apparent to those skilled in the relevant art(s) without departing from the spirit and scope of the present disclosure.

### CONCLUSION

The Detailed Description referred to accompanying figures to illustrate exemplary embodiments consistent with the disclosure. References in the disclosure to “an exemplary embodiment” indicates that the exemplary embodiment described can include a particular feature, structure, or characteristic, but every exemplary embodiment may not necessarily include the particular feature, structure, or characteristic. Moreover, such phrases are not necessarily referring to the same exemplary embodiment. Further, any feature, structure, or characteristic described in connection with an exemplary embodiment can be included, independently or in any combination, with features, structures, or characteristics of other exemplary embodiments whether or not explicitly described.

The Detailed Description is not meant to limiting. Rather, the scope of the disclosure is defined only in accordance with the following claims and their equivalents. It is to be appreciated that the Detailed Description section, and not the Abstract section, is intended to be used to interpret the claims. The Abstract section can set forth one or more, but not all exemplary embodiments, of the disclosure, and thus, are not intended to limit the disclosure and the following claims and their equivalents in any way.

The exemplary embodiments described within the disclosure have been provided for illustrative purposes and are not intended to be limiting. Other exemplary embodiments are possible, and modifications can be made to the exemplary embodiments while remaining within the spirit and scope of the disclosure. The disclosure has been described with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

Embodiments of the disclosure can be implemented in hardware, firmware, software application, or any combination thereof. Embodiments of the disclosure can also be implemented as instructions stored on a machine-readable medium, which can be read and executed by one or more processors. A machine-readable medium can include any mechanism for storing or transmitting information in a form readable by a machine (e.g., a computing circuitry). For example, a machine-readable medium can include non-transitory machine-readable mediums such as read only memory (ROM); random access memory (RAM); magnetic disk storage media; optical storage media; flash memory devices; and others. As another example, the machine-readable medium can include transitory machine-readable medium such as electrical, optical, acoustical, or other forms of propagated signals (e.g., carrier waves, infrared signals, digital signals, etc.). Further, firmware, software application, routines, instructions can be described herein as performing certain actions. However, it should be appreciated that such descriptions are merely for convenience and that such actions in fact result from computing devices, processors, controllers, or other devices executing the firmware, software application, routines, instructions, etc.

The Detailed Description of the exemplary embodiments fully revealed the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

What is claimed is:

1. A virtual window system, comprising:
a position sensor configured to determine a relative distance between the virtual window system and person viewing the virtual window system;
processor circuitry configured to:
select a viewable image area from an image that corresponds to the relative distance to adapt the image to a field of view of a scene of the person at the relative distance, and
scale the viewable image area to occupy a display area to adapt the field of view of the scene to a field of view of a window of the person at the relative distance; and
a display device configured to display the scaled viewable image area onto the display area to emulate the person viewing a real-world window at the relative distance.

2. The virtual window system of claim 1, wherein the processor is configured to select the viewable image area in accordance with a geometric projection technique.

3. The virtual window system of claim 2, wherein the geometric projection technique is based upon a geometric law of similar triangles.

4. The virtual window system of claim 1, wherein the position sensor is further configured to determine a light of sight of the person, and
wherein the processor is further configured to:
select the viewable image area from the image based upon the relative distance and the light of sight of the person.

5. The virtual window system of claim 1, further comprising:
a user interface configured to allow the person to select the image from among a library of images.

6. The virtual window system of claim 5, further comprising:
communication circuitry configured to receive the image over a communication network.

7. The virtual window system of claim 1, further comprising:
content storage that stores a plurality of viewable image areas, each viewable image area from among the plurality of viewable image areas corresponding to a different relative distance from among a plurality of relative distances, and
wherein the processor is configured to select the viewable image area that corresponds to the relative distance from among the plurality of viewable image areas.

8. A method for emulating a real-world window, the method comprises:
determining, by a virtual window system, a relative distance between the virtual window system and person viewing the virtual window system;
selecting, by the virtual window system, a viewable image area from an image that corresponds to the relative distance to adapt the image to a field of view of a scene of the person at the relative distance;
scaling, by the virtual window system, the viewable image area to occupy a display area to adapt the field of view of the scene to a field of view of a window of the person at the relative distance; and
displaying, by the virtual window system, the scaled viewable image area onto the display area to emulate the person viewing the real-world window at the relative distance.

9. The method of claim 8, wherein the selecting comprises:
selecting the viewable image area in accordance with a geometric projection technique.

10. The method of claim 9, wherein the geometric projection technique is based upon a geometric law of similar triangles.

11. The method of claim 8, wherein the determining further comprises:
determining a light of sight of the person, and
wherein the selecting further comprises:
selecting the viewable image area from the image based upon the relative distance and the light of sight of the person.

12. The method of claim 8, further comprising:
selecting, by the virtual window system, the image from among a library of images.

13. The method of claim 12, further comprising:
receiving, by the virtual window system, the image over a communication network.

14. The method of claim 8, further comprising:
storing, by the virtual window system, a plurality of viewable image areas, each viewable image area from among the plurality of viewable image areas corresponding to a different relative distance from among a plurality of relative distances, and
wherein the selecting comprises:
selecting the viewable image area that corresponds to the relative distance from among the plurality of viewable image areas.

15. A virtual window system, comprising:
a virtual window device configured to determine a relative distance between the virtual window system and person viewing the virtual window system; and
a virtual window server configured to:
select a viewable image area from an image that corresponds to the relative distance to adapt the image to a field of view of a scene of the person at the relative distance, and
scale the viewable image area to occupy a display area to adapt the field of view of the scene to a field of view of a window of the person at the relative distance,
wherein virtual window device is further configured to display the scaled viewable image area onto the display area to emulate the person viewing a real-world window at the relative distance.

16. The virtual window system of claim 15, wherein the virtual window server is configured to select the viewable image area in accordance with a geometric projection technique.

17. The virtual window system of claim 16, wherein the geometric projection technique is based upon a geometric law of similar triangles.

18. The virtual window system of claim 15, wherein the virtual window device is further configured to determine a light of sight of the person, and
wherein the virtual window server is further configured to:
select the viewable image area from the image based upon the relative distance and the light of sight of the person.

19. The virtual window system of claim 15, wherein the virtual window device is further configured to allow the person to select the image from among a library of images.

20. The virtual window system of claim 19, wherein the virtual window device is configured to receive the scaled viewable image area from the virtual window server over a communication network.
